(19) United States
(12) Patent Application Publication
(10) Pub. No.: US 2006/0203091 A1
(43) Pub. Date: Sep. 14, 2006

(54) Switching on/off concept for an automobile night vision system

(75) Inventors: Helmuth Eggers, Ulm (DE); Gerhard Kurz, Wendlingen (DE); Juergen Seekircher, Ostfildern (DE); Thomas Mohlgemuth, Aichtal (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/549,436

(22) PCT Filed: Mar. 4, 2004
(86) PCT No.: PCT/EP04/02165

§ 371 Date: Sep. 15, 2005

(30) Foreign Application Priority Data
Mar. 24, 2003 (DE) 103 13 003.9

(51) Int. Cl. H04N 7/18; H04N 5/33; H04N 9/47

(52) U.S. Cl. 348/148; 348/164

(57) ABSTRACT

First commercial automobile night vision systems are already available on the market. These should assist the driver in difficult situations involving poor visibility, particularly in darkness or fog. To this end, systems of this type have an active infrared illuminating device (2), a camera (3) for recording infrared images, and an image display (1) for playing back the image information obtained by the system. In doing this, the activation of the active infrared illuminating device (2) ensues according to an evaluation of operating parameters (5) and parameters (6) of the surroundings (4). In addition, according to a feature of the present invention, a controller (7), which is independent of the evaluator (4), is provided for directly activating/deactivating the image display (1). The controller (7) enables the driver to immediately obtain information regarding a successful activation of the night vision system.

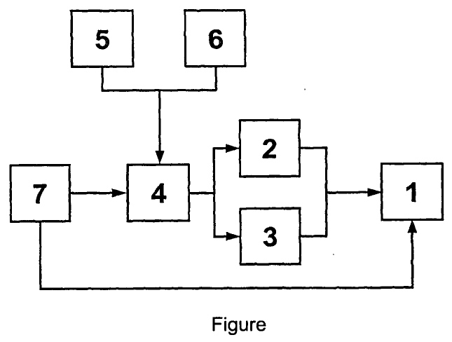

The present invention is directed to a switch-on/switch-off concept for an automotive night vision system.

First commercial automotive night vision systems are already on the market. Their purpose is to assist the driver in difficult situations, under conditions of poor visibility, particularly darkness, as well as fog. Night vision systems exist in the automobile sector, for example, which include an active infrared illumination for illuminating the ambient environment immediately ahead of the vehicle using infrared radiation. Such systems first sense the ambient environment immediately ahead of the vehicle using infrared sensors. The recorded ambient data are then processed into an image by a data processing unit and imaged onto an image display, where the driver can retrieve them, as needed. In order not to distract the driver unnecessarily, such related art systems, once they have been activated by the driver, are automatically controlled in consideration of operating and ambient parameters.

The Japanese patent application JP 2001344700 describes a display unit for a vehicle. The purpose of the display unit is to enhance safety, particularly when the ambient environment immediately ahead of the vehicle is blocked from the driver's direct view. Infrared images recorded by an infrared camera are shown on an image display. The infrared images are preferably displayed on the image display when an evaluation means suited for analyzing ambient parameters ascertains that the vehicle is driving into a tunnel. During operation of the display unit, it is taken into account whether the vehicle is moving within a specific vehicle surrounding field in which it is not necessarily essential for infrared images to be displayed. This is the case, for example, when the means for assessing the vehicle's surrounding field do not detect any approaching vehicles. In this connection, infrared images are also not displayed when the vehicle is located in a tunnel.

The Japanese patent application JP 2000215398 describes a display unit in a vehicle for displaying surrounding field information. It is intended that the surrounding field information be indicated to the driver in an effective manner. In the process, the

infrared images recorded by a camera are displayed on an image display via a control unit, when an evaluation means for analyzing operating parameters ascertains that the front headlight switch is actuated. In this case, the infrared images are also displayed as a function of information acquired by an evaluations means for analyzing ambient parameters, for example, in the case that it is nighttime and the ambient environment appears to be dark. Another case is when the vehicle is located outside of a tunnel and thick fog conditions prevail in the ambient surrounding area. Yet another instance is when the hand brake is actuated, even when the light switch is switched off. In such a case, it cannot be immediately recognized, however, whether the display unit had been successfully activated by the driver.

The object of the present invention is, therefore, to devise a switch-on/switch-off concept for an automotive night vision system which indicates when a successful activation has taken place.

The objective is achieved in accordance with the present invention by a switch-on/switch-off concept having the features set forth in claim 1. Advantageous embodiments and refinements are characterized in the dependent claims.

A switch-on/switch-off concept for the image display of an automotive night vision system is provided in accordance with the present invention. The night vision system includes an active infrared illumination, a camera for recording infrared images, as well as an image display for reproducing image information. In addition, an evaluation means is provided, which is suited for analyzing operating and/or ambient parameters, on the basis of this analysis, the active infrared illumination of the night vision system being activated. Also provided is a control means that is independent of this evaluation means for activating or deactivating the night vision system. Along the lines of the present invention, the image display is activated or deactivated directly by the control means. In the process, the analysis of operating and/or ambient parameters is not considered by the evaluation means.

Whenever the night vision system is activated by the control means, the image display is also directly activated. In this connection, a display is produced in any case on

the image display and/or there is a change in the previous display, even when, based on the analysis of operating and/or ambient parameters, there is no need whatsoever for night vision functionality, or when it is not permissible to operate the active infrared illumination, due to safety considerations. A textual or symbolic message may be shown on the image display, for example, indicating activation of the night vision system. This makes it is very advantageously possible for the driver to immediately receive information indicating a successful activation of the night vision system.

In one advantageous embodiment of the present invention, the control means for activating or deactivating the image display is constituted of a switch. For this, electromechanical or electronic switches are known, for example, to one skilled in the art. The switching stage of the switch may have a notch, for example, or the switch may be designed as a momentary-contact control switch. In this connection, the switch is mounted directly on the housing of the image display or in its vicinity. However, it is also conceivable for the switch to be mounted at a location where other switching elements for operating illumination devices of the vehicle are located, or for it even to be integrated in such switching elements. In this context, any position in the cockpit of the vehicle that the driver is able to reach is suited. A further advantage is attained when the display surface of the image display is designed as a touch screen, so that fulfills the control button function. It is also conceivable, however, for the control means to be influenced by acoustic instructions, for example.

Another advantageous embodiment of the present invention provides for the control means to be influenced on the basis of internal or external diagnostic systems. In this connection, the image display is operated by the control means independently of operating and/or ambient parameters, for example for service and diagnostic purposes. Within the framework of the diagnostics, it may be necessary for components of the night vision system, as well as the image display to be able to be operated independently of one another. It may be a question both of external diagnostic systems, for example, for checking the active illumination, as well as of internal diagnostic systems, which utilize the image display for reproducing information, for example. Safety aspects may require that the individual components of the night vision system, as well as the image display be separately operable. This is particularly true of service stations, where vehicles are typically situated in one location and people are situated in their surrounding field.

The image display may effectively reproduce image information from at least one additional camera which is linked to the night vision system and, in particular, is sensitive in the visible wavelength range. Thus, it is possible for an appropriate image of the surrounding area to be presented to the driver, even when an application of the night vision functionality does not make any sense, for example in the daytime. In particular, for as long as the infrared illumination is inactive, image information recorded by the camera operating in the visible wavelength range may be shown on the image display. If the night vision system is then activated, the switch is also made to displaying the image data from the infrared camera. Once this night vision display is activated, it proves to be especially beneficial to examine the quality of the infrared image. A decision element is provided as an appropriate means for examining the quality of the infrared image. If the decision element ascertains a satisfactory quality, the infrared image may continue to be displayed. If the quality is less than satisfactory, then the quality of the image information recorded by the camera operating in the visible range is analyzed. If a better quality is ascertained, the switch is made back to the display of the image information recorded by the camera operating in the visible wavelength range. Due to the fact that a threshold value is predefined in each instance for the quality, the switch between the different image information is preferably made automatically. The threshold values may be fixed by the driver or varied as a function of operating and ambient parameters. Of course, it is also conceivable for a means to be provided which enables a direct switch to be made between the image information, independently of the quality.

Another advantageous embodiment of the present invention provides for the image display to be deactivated in the case that a malfunction prevents the image information from being continually refreshed. In this case, malfunctions may be caused, for example, by individual components of the night vision system or by other vehicle systems. For that reason, a monitoring unit is provided for monitoring the individual components of the night vision system. In addition, it is used for monitoring the representation on the image display to check if the image information is being continuously up-dated. A comparison with odometry data is particularly suited in this case. In the case of a moving vehicle, for example, the image scene must continually change. On the other hand, in the case of a stationary vehicle, the image scene should not change. However, individual objects in the image scene may move, for example. In this connection, image processing methods for analyzing such differences between a moving scene and moving objects within a scene, are known to one skilled in the art.

The figure shows exemplarily the schematic design of the switch-on/switch-off concept according to the present invention for an automotive night vision system. The night vision system includes a camera (3) which records surrounding field information and converts the recorded surrounding field information into image information. It also includes an image display (1) for reproducing image information. In addition, the night vision system includes an active infrared illumination (2) for illuminating the surrounding field using infrared radiation. Also included is an evaluation means (4) for analyzing operating parameters (5) and/or ambient parameters (6), on the basis of this analysis, active infrared illumination (2), as well as camera (3) being activated. Independently of this evaluation means (4), an additional control means (7) is provided for activating or deactivating the night vision system. In addition, image display (1) is activatable or deactivatable. Thus, control means (7) acts directly on image display (1).

### REFERENCE NUMERAL LIST

1 image display
2 active infrared illumination
3 camera
4 evaluation means
5 operating parameters
6 ambient parameters
7 control means

1 to 7. (canceled)

8. An automotive night vision system, which comprises:
an active infrared illumination;
a camera for recording infrared images;
an image display for reproducing image information;
an evaluator arranged and configured to analyze parameters, to activate the active infrared illumination as a function of the analysis; and
a controller, independent of the evaluator, for activating and deactivating the night vision system, wherein the image display is activated and deactivated directly by the controller independently of the analysis of parameters.

9. The automotive night vision system of claim 8 wherein the controller comprises a switch used for activating and deactivating the image display.

10. The automotive night vision system of claim 8, wherein the controller is operable as a function of diagnostic systems.

11. The automotive night vision system of claim 8, wherein the image display is arranged and configured to reproduce image information from at least one additional camera coupled to the night vision system and sensitive in the visible wavelength range.

12. The automotive night vision system of claim 11, wherein, when the infrared illumination is inactive, image information recorded by the additional camera operating in the visible wavelength range is shown on the image display.

13. The automotive night vision system of claims 10 wherein, when satisfactory quality is ascertained, the image display is operated to display the infrared image.

14. The automotive night vision system of claim 8, wherein the image display is deactivated in a case when a malfunction prevents image information from being continually refreshed.
